(19) United States
(12) Patent Application Publication
(10) Pub. No.: US 2014/0219682 A1
(43) Pub. Date: Aug. 7, 2014

(54) CHARGING ROLLER

(71) Applicant: FUJI XEROX CO., LTD., Tokyo (JP)

(72) Inventors: Satoru TSUTO, Kanagawa (JP); Takuro HAGIWARA, Kanagawa (JP); Minoru ROKUTAN, Kanagawa (JP); Masao OMORI, Kanagawa (JP)

(73) Assignee: FUJI XEROX CO., LTD., Tokyo (JP)

(21) Appl. No.: 14/029,166

(22) Filed: Sep. 17, 2013

(30) Foreign Application Priority Data
Feb. 6, 2013 (JP) 2013-021199

(51) Int. Cl. G03G 15/02

(52) U.S. Cl. CPC G03G 15/0233
USPC 399/176

(57) ABSTRACT

A charging roller includes a conductive core, a resistive elastic layer disposed on the conductive core, and a surface layer disposed on the resistive elastic layer. The impedances of the resistive elastic layer and the surface layer measured at an environmental temperature of about 10° C. and a humidity of about 15% RH in a range of alternating voltage frequencies of an image-forming apparatus used satisfy:

|ZE/(ZE+ZS)|≦0.81

where ZE is the impedance of the resistive elastic layer, and ZS is the impedance of the surface layer.

### CROSS-REFERENCE TO RELATED APPLICATIONS

This application is based on and claims priority under 35 USC 119 from Japanese Patent Application No. 2013-021199 filed Feb. 6, 2013.

### BACKGROUND

1. Technical Field

The present invention relates to charging rollers.

2. Summary

According to an aspect of the invention, there is provided a charging roller including a conductive core, a resistive elastic layer disposed on the conductive core, and a surface layer disposed on the resistive elastic layer. The impedances of the resistive elastic layer and the surface layer measured at an environmental temperature of about 10° C. and a humidity of about 15% RH in a range of alternating voltage frequencies of an image-forming apparatus used satisfy:

|ZE(ZE+ZS)|≦0.81

where ZE is the impedance of the resistive elastic layer, and ZS is the impedance of the surface layer.

### BRIEF DESCRIPTION OF THE DRAWINGS

Exemplary embodiments of the present invention will be described in detail based on the following figures, wherein:

FIG. 1 is a schematic view illustrating the structure and functions of an image-forming section in an image-forming apparatus;

FIG. 2 is a graph illustrating the relationship between the alternating current supplied to a charging roller and the surface potential of a photoreceptor drum, showing a knee-point voltage;

FIG. 3 illustrates an example of a measurement scheme for measuring impedance;

FIG. 4 illustrates an equivalent circuit model of the resistance R and capacitance C of the charging roller;

FIG. 5 illustrates an example of a Cole-Cole plot (Nyquist plot) based on impedance measurements;

FIG. 6 is an example of a graph plotting the phase difference between applied voltage and response current against the frequency of the applied voltage;

FIG. 7A is a graph illustrating an example of the relationship between phase θ and white spot disappearance margin at a frequency of the applied voltage of 1,306 Hz;

FIG. 7B is a graph illustrating an example of the relationship between impedance ratio and white spot disappearance margin at a frequency of the applied voltage of 1,306 Hz;

FIG. 8A is a table showing the basic formulations for Examples 1 and 2 and Comparative Examples 1 and 2;

FIG. 8B is a table showing the impedances measured and white spot disappearance margins determined in Examples 1 and 2 and Comparative Examples 1 and 2; and

FIG. 9 is a graph illustrating the impedances measured at an environment temperature of 10° C. and a humidity of 15% RH in a range of alternating voltage frequencies of 800 to 3,000 Hz in Examples 1 and 2 and Comparative Examples 1 and 2.

### DETAILED DESCRIPTION

Exemplary embodiments and specific examples of the present invention will now be described in more detail with reference to the drawings, although these exemplary embodiments and specific examples are not intended to limit the present invention.

It should be noted that the drawings used in the following description are schematic and not to scale, and the members other than those necessary for illustration are not shown.

### (1) Structure and Operation of Charging Roller and Image-Forming Apparatus

### (1.1) Overall Structure of Charging Roller

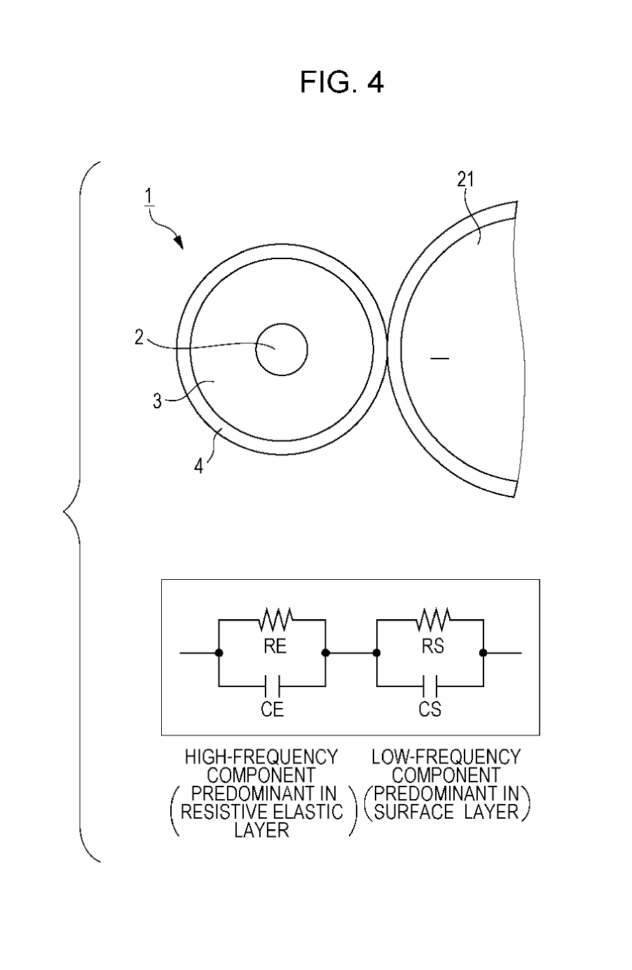

As shown in FIG. 4, a charging roller 1 according to an exemplary embodiment includes a conductive core 2, a resistive elastic layer 3 disposed on the conductive core 2, and the surface layer 4 disposed on the resistive elastic layer 3.

The charging roller 1 is used with an image-forming apparatus including a contact charging device. The impedances of the resistive elastic layer 3 and the surface layer 4 measured at an environmental temperature of 10° C. or about 10° C. and a humidity of 15% RH or about 15% RH in the range of alternating voltage frequencies of the image-forming apparatus used satisfy |ZE/(ZE+ZS)|≦0.81, where ZE is the impedance of the resistive elastic layer 3, and ZS is the impedance of the surface layer 4.

### (1.2) Overall Structure of Image-Forming Apparatus

Contact charging is a type of charging in which a photoreceptor drum, acting as an image carrier, is charged by bringing a conductive charging member such as a charging roller into direct contact with the photoreceptor drum. Contact charging produces little ozone and nitrogen oxide and has various advantages, including environmental friendliness, space saving, low cost, and high power supply efficiency. Contact charging is widely used for electrophotographic image-forming apparatuses.

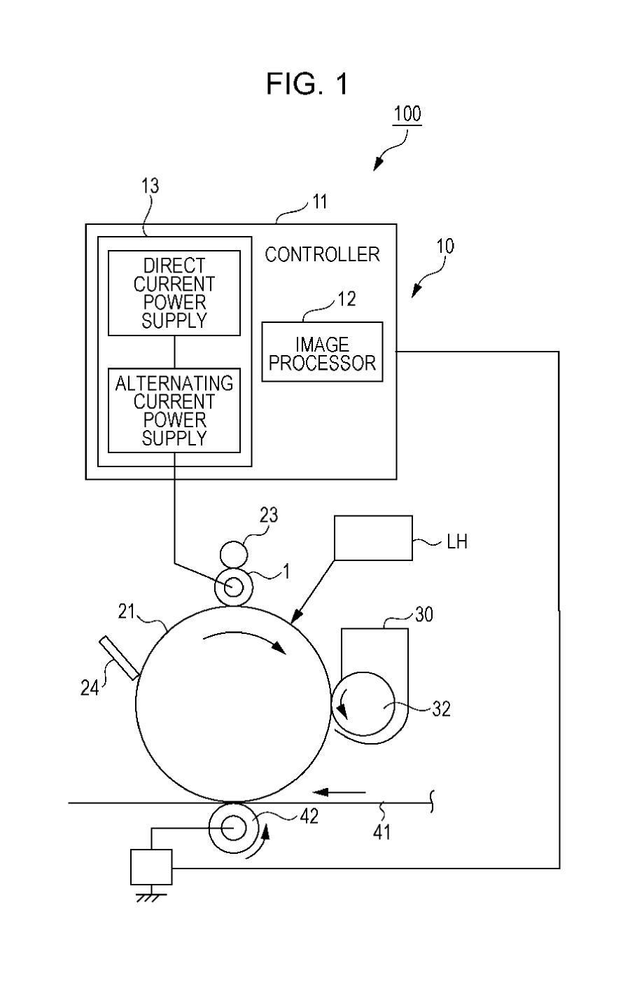

FIG. 1 is a schematic view illustrating the functions of an image-forming section in an image-forming apparatus 100 including the charging roller 1 according to this exemplary embodiment. The image-forming section includes a control device 10, a photoreceptor drum 21, an exposure device LH, a developing device 30, and a first transfer roller 42.

As shown in FIG. 1, the charging roller 1 is rotatably disposed in contact with the photoreceptor drum 21. A cleaning roller 23 is disposed opposite and in contact with the charging roller 1. The exposure position of the exposure device LH is set downstream of the charging roller 1. A developing roller 32 is disposed opposite the photoreceptor drum 21 downstream of the exposure position. The first transfer roller 42 is disposed opposite the photoreceptor drum 21 with an intermediate transfer belt 41 held therebetween downstream of the developing roller 32, forming a transfer section. A cleaning blade 24 is elastically disposed in contact with the photoreceptor drum 21 downstream of the transfer section and upstream of the charging roller 1.

The control device 10 includes a controller 11 that controls the operation of the image-forming apparatus 100, an image processor 12 that is controlled by the controller 11, and a power supply device 13. The power supply device 13 applies a superimposed voltage of a direct voltage and an alternating voltage to the charging roller 1 and also applies the necessary voltage to other components such as the developing roller 32, the first transfer roller 42, and a second transfer roller 43.

The image processor 12 converts print information received from an external information-transmitting apparatus (such as a personal computer) into image information for forming a latent image and outputs a drive signal to the exposure device LH at a predetermined timing. The exposure device LH used in this exemplary embodiment includes a light-emitting diode (LED) head having a linear array of LEDs.

### (1.3) Operation of Image-Forming Section

In contact charging with the charging roller 1, a superimposed voltage of a direct voltage (Vdc) and an alternating voltage (Vac) for charging is applied to the charging roller 1.

The direct voltage (Vdc) alone cannot uniformly charge the charging roller 1 because a current would flow across the photoreceptor drum 21 only where the resistance is low. In addition, if the surface of the photoreceptor drum 21 is locally contaminated, the contaminated portion might not be charged. Accordingly, a superimposed voltage of a direct voltage (Vdc) and an alternating voltage (Vac) is applied to charge the surface of the photoreceptor drum 21.

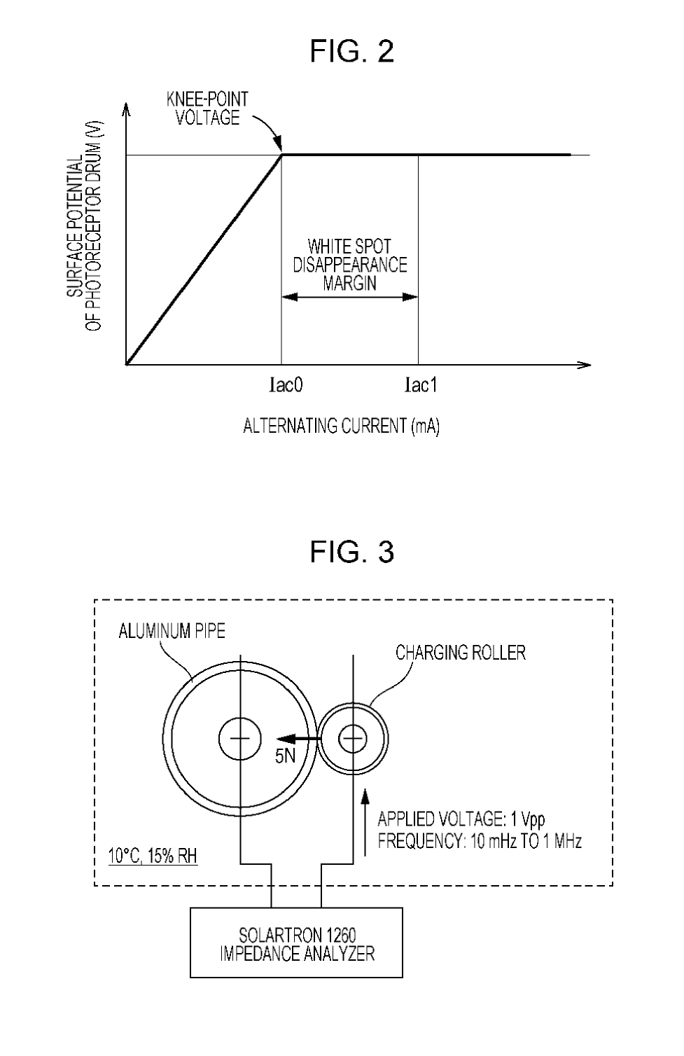

If a certain superimposed voltage of a direct voltage (Vdc) and a alternating voltage (Vac) is applied to the charging roller 1 disposed in contact with the rotating photoreceptor drum 21, the surface potential of the photoreceptor drum 21 does not rise above a certain voltage (knee-point voltage) even if the alternating voltage (peak-to-peak, Vpp) is increased above a certain level (saturation current Iac0, see FIG. 2).

In practice, the alternating current is increased to an alternating current (Iac1) higher than the saturation current (Iac0) to ensure high image quality and permit environmental variations. If the alternating current (Iac1) is too high, the photoreceptor drum 21 wears. If the alternating current (Iac1) is too low, the charging roller 1 cannot be uniformly charged, and particularly, image defects such as white spots tend to occur when an image is formed in a low-temperature, low-humidity environment.

To reduce white spots, it is common to set the alternating current (Iac1) to a level that is higher than the knee-point current (Iac0) to a certain extent. As the amplitude of the alternating voltage (Vpp) is gradually increased from the knee-point current (Iac0), fewer white spots occur, and they eventually disappear. The range from the knee-point current (Iac0) to the alternating current (Iac1) at which white spots disappear is referred to as a white spot disappearance margin.

It is also common to polish the surface of the charging roller 1 during manufacture so that the surface layer 4 has a ten-point average surface roughness Rz of 3 to 12 μm to reduce local abnormal discharge due to height differences between peaks and valleys in the surface of the surface layer 4 and thereby reduce image defects such as white spots.

If the surface layer 4 has a ten-point average surface roughness Rz of less than 3 μm, foreign matter such as toner and external additive may adhere to the surface layer 4. If the surface layer 4 has a ten-point average surface roughness Rz of more than 12 μm, toner and paper dust are readily deposited in valleys in the surface of the surface layer 4, and local abnormal discharge also occurs due to large height differences between peaks and valleys in the surface of the surface layer 4. This prevents uniform charging and thus results in image defects such as white spots.

Extremely small white spots may also occur if the surface layer 4 has a low ten-point average surface roughness Rz, and a higher current is needed to reduce such white spots. Thus, if the surface layer 4 has a ten-point average surface roughness Rz below the lower limit, an extremely high current is needed, which results in considerable discharge noise.

The charging roller 1 may have a volume resistivity of 10⁵ to 10¹⁰ Ω·cm. Any higher volume resistivity would result in image defects due to insufficient discharge.

Research on the above problem has revealed that white spots may be reduced with reduced wear of the photoreceptor drum 21 if the absolute value of the ratio of the impedances of the resistive elastic layer 3 and the surface layer 4 falls within a particular range when the impedances are measured at an environmental temperature of 10° C. or about 10° C. and a humidity of 15% RH or about 15% RH in the range of alternating voltage frequencies of the image-forming apparatus used.

Specifically, white spots may be reduced with reduced wear of the photoreceptor drum 21 if the impedances of the resistive elastic layer 3 and the surface layer 4 measured at an environmental temperature of 10° C. or about 10° C. and a humidity of 15% RH or about 15% RH in a range of alternating voltage frequencies of the image-forming apparatus used of 800 to 3,000 Hz or about 800 to about 3,000 Hz satisfy |ZE/(ZE+ZS)|≦0.81, where ZE is the impedance of the resistive elastic layer 3, and ZS is the impedance of the surface layer 4.

In particular, white spots may be reduced with reduced wear of the photoreceptor drum 21 if the resistances and capacitances of the resistive elastic layer 3 and the surface layer 4 satisfy RE≦6.0×10⁴ Ω·m, CE≧3.5×10⁻¹⁰ F/m, RS≧3.6×10⁶ Ω·m, and CS 2.2×10⁻⁹ F/m, where RE is the resistance of the resistive elastic layer 3 per unit length, CE is the capacitance of the resistive elastic layer 3 per unit length, RS is the resistance of the surface layer 4 per unit length in the axial direction of the charging roller 1, and CS is the capacitance of the surface layer 4 per unit length in the axial direction of the charging roller 1.

### (2) Measurement and Calculation of Impedance

### (2.1) Method for Measuring Impedance

FIG. 3 illustrates an example of a measurement scheme for measuring impedance. A method for measuring the impedance ZE of the resistive elastic layer 3 and the impedance ZS of the surface layer 4 of the charging roller 1 will now be described with reference to the drawings.

The impedance is measured using a measurement apparatus, such as an impedance analyzer or a frequency analyzer, capable of measurement over the range of 0.1 Hz to 1 MHz. For example, a Solartron 1260 impedance analyzer may be used.

The charging roller 1 is brought into contact with and pressed against an aluminum pipe (metal conductor) having a diameter of 30 mm and a surface roughness Rmax of 1.6 μm or less under conditions equivalent to those in the image-forming apparatus used (with a pressing force of 5N on one side). The charging roller 1 is at rest during the impedance measurement.

Specifically, the impedance is measured by applying an alternating voltage of 1 Vpp from higher frequencies over the frequency range of 1 MHz to 10 mHz in an environment at a temperature of 10° C. or about 10° C. and a humidity of 15% RH or about 15% RH.

As shown in FIG. 4, the layer structure of the charging roller 1 approximates to an equivalent circuit model in which each layer is connected in series to the other and is composed of a resistance R and a capacitance C that are connected in parallel. An adhesive layer is excluded because it does not affect the electrical characteristics; it may be included if it affects the electrical characteristics.

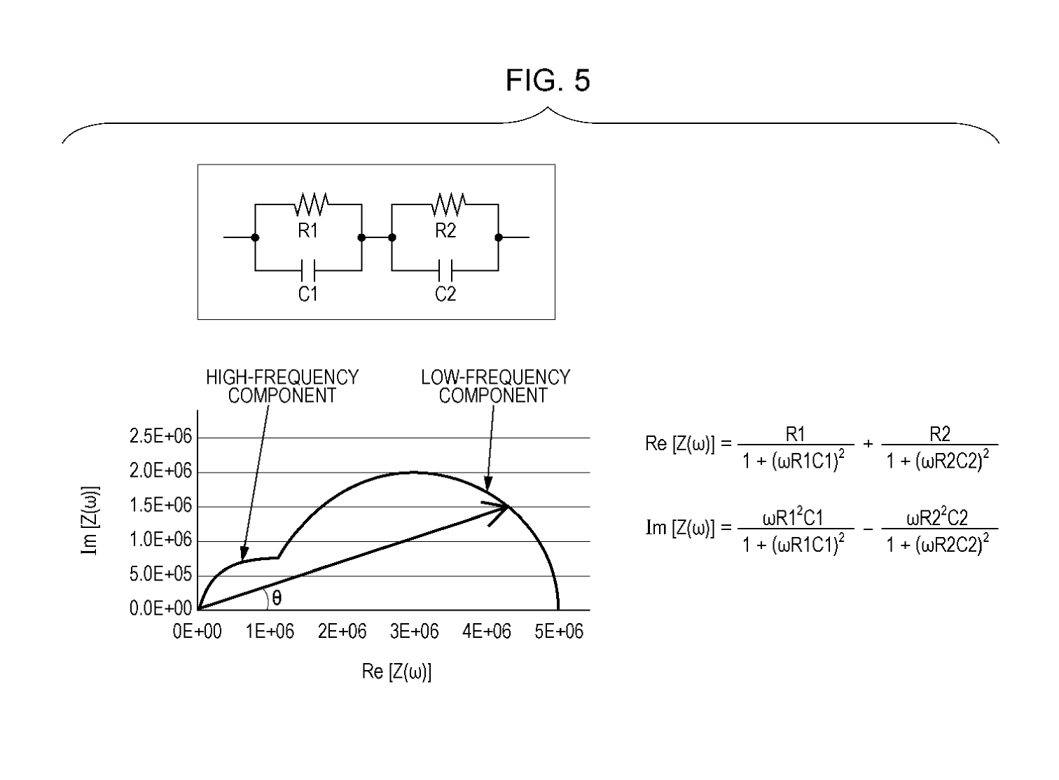

As shown in FIG. 5, the impedance measurement gives the real impedance Re[Z(ω)] and the imaginary impedance Im[Z(ω)] at each frequency. With Re[Z(ω)] and Im[Z(ω)], the RC constant of the charging roller 1 is determined by a method called the Cole-Cole method. For an equivalent circuit in which a resistance R and a capacitance C are connected in parallel, a semicircular curve is drawn whose center lies on the Re[Z(ω)] axis and whose diameter is the resistance R. This technique allows nondestructive measurement of the RC constant of the charging roller 1.

Fitting may be performed using the Instant Fit function of the ZView2 analysis software available from Solartron.

Results of changes in formulation and measurements for each layer show that the resistive elastic layer 3 has a higher natural frequency than the surface layer 4. The RC constant of each layer may be determined from a semicircle for each frequency range in a Cole-Cole plot (Nyquist plot).

As a result, the resistance RE and the capacitance CE of the resistive elastic layer 3 and the resistance RS and the capacitance CS of the surface layer 4 are given. The time constant τ₀ is the product of the resistance and the capacitance of each layer. The natural frequency f₀ is the reciprocal of τ₀ divided by 2π.

The measured impedance of the surface layer 4 contains not only the impedance made up of the resistance and the capacitance of the material of the surface layer 4, but also the impedance of an air layer in the surface layer structure (peaks and valleys) and in a wedge-shaped gap between the charging roller 1 and the aluminum pipe.

It is therefore desirable to measure the impedance in a state close to actual use with the image-forming apparatus used because the impedance is affected not only by the surface layer structure, but also by other factors, including the crown shape of the charging roller 1 in the axial direction and the nip area (nip force) thereof.

White spots are more likely to occur in a low-temperature, low-humidity environment. To control the characteristic value of the charging roller 1, measurements are performed in an environment at a temperature of 10° C. or about 10° C. and a humidity of 15% RH or about 15% RH.

A charging roller 1 that utilizes the semiconductivity of epichlorohydrin rubber is generally environment-dependent. In particular, the charging roller 1 has a problem in that the discharge characteristics vary as the resistance increases in a low-temperature environment. The discharge characteristics of the charging roller 1 are closely related to the resistance characteristics of the resistive elastic layer 3 based on epichlorohydrin rubber.

For example, in contact charging with the charging roller 1, as described above, a superimposed voltage of a direct voltage (Vdc) and an alternating voltage (Vac) is applied to the charging roller 1. Based on the process speed, the visibility of streaks, and the economical efficiency of the power supply capacity, the frequency applied is determined such that discharge occurs five or six times each time the photoreceptor drum 21 advances 1 mm in the circumferential direction (line pair). However, a phase delay may occur depending on the relationship between the resistance and capacitance of the charging roller 1 and the frequency applied.

It has been found that if there is a large phase delay, the alternating current (Iac1) needs to be increased to ensure a sufficient white spot disappearance margin, and a higher power is needed to reduce white spots.

A phase advance indicates that an alternating current flows more easily through the capacitance C than the resistance R in the above equivalent circuit model, whereas a phase delay indicates that a current flows more easily through the resistance R.

Thus, when there is a large phase delay, a power loss due to resistance is occurring, which results in more white spots.

### (2.2) Calculation of Impedance

The impedance is expressed by two parameters: the amplitude ratio of the applied voltage (1 Vpp) to the response current and the phase difference between the applied voltage (1 Vpp) and the response current. The frequency at which the phase θ is maximized may be determined from the phase difference between the applied voltage and the response current plotted against the frequency of the applied voltage (1 Vpp).

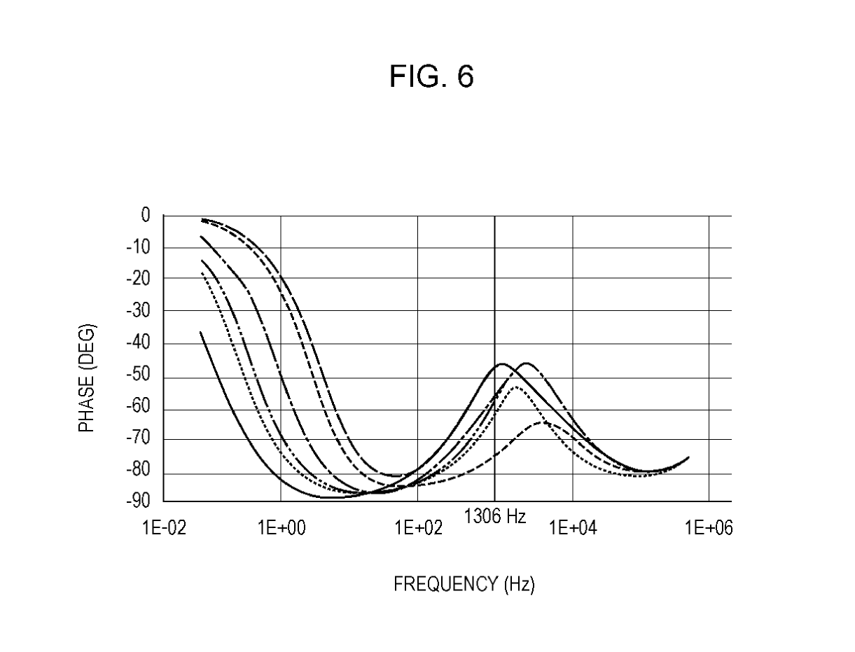

As shown in FIG. 6, in the phase of the charging roller 1, which has two natural frequencies in the high frequency range and the low frequency range, there are two phase peaks in the high frequency range and the low frequency range (the low frequency side approaches a phase of 0°, which is herein referred to as “peak”). Thus, the same phase appears at different frequencies. If the phase θ is used as the characteristic value, the white spot disappearance margin is not uniquely determined.

Accordingly, the impedance ratio is defined as a characteristic value that may be uniquely controlled to quantitatively and uniquely represent the degree of loss due to the impedance ZE, which is the combination of the resistance RE and the capacitance CE of the resistive elastic layer 3, and the impedance ZS, which is the combination of the resistance RS and the capacitance CS of the surface layer 4, relative to the impedance of the entire charging roller 1.

The impedance Ze of the resistive elastic layer 3 and the impedance ZS of the surface layer 4 are separately calculated. Each impedance is represented by R/(1+jωRC) (where j is the imaginary unit), and the impedance ratio is represented by the absolute value of ZE/(ZE+ZS).

That is, the impedance ratio is the loss impedance that occurs in the range of frequencies of the applied voltage divided by the impedance of the entire charging roller 1.

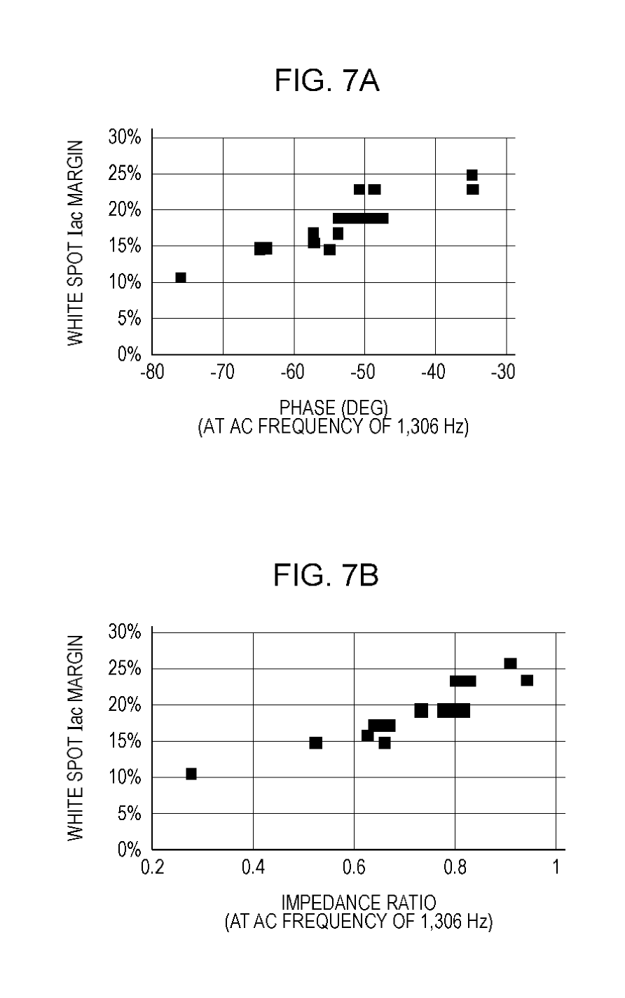

FIG. 7A is a graph illustrating the relationship between the phase θ and the white spot disappearance margin at a frequency of the applied voltage of 1,306 Hz. FIG. 7B is a graph illustrating the relationship between the impedance ratio and the white spot disappearance margin at a frequency of the applied voltage of 1,306 Hz.

The relationship between the phase θ and the white spot disappearance margin at a frequency of the applied voltage of 1,306 Hz in FIG. 7A shows that the phase θ is not suitable as the characteristic value used for controlling the properties of the charging roller 1 because there are different white spot disappearance margins corresponding to the same phase in a wide range.

The relationship between the impedance ratio and the white spot disappearance margin at a frequency of the applied voltage of 1,306 Hz in FIG. 7B shows that the impedance ratio is highly unique as the characteristic value used for controlling the properties of the charging roller 1 because there are different white spot disappearance margins corresponding to the same impedance ratio only in a limited range.

### (3) Overall Structure of Charging Roller

The components of the charging roller 1 according to this exemplary embodiment, such as the conductive core 2, the resistive elastic layer 3, and the surface layer 4, will now be described in more detail.

### (3.1) Conductive Core

The conductive core 2 of the charging roller 1 may be made of a material such as free-cutting steel or stainless steel. The material and the method of surface treatment used are selected depending on, for example, slidability. A nonconductive material may be made conductive by a common surface treatment technique such as plating or may be used without surface treatment.

Because the conductive core 2 is brought into contact with the photoreceptor drum 21 with the resistive elastic layer 3 therebetween at an appropriate nip pressure (with a pressing force of 5N on one side), the material used for the conductive core 2 may have sufficient strength not to bend during nipping or a shaft diameter that provides sufficient rigidity relative to the shaft length.

### (3.2) Adhesive Layer

The resistive elastic layer 3 may be formed around the conductive core 2 with an adhesive layer therebetween. Examples of adhesives for forming the adhesive layer include, but not limited to, rubbers and resins such as polyolefin resins, chlorinated rubbers, acrylic resins, epoxy resins, polyurethane resins, nitrile rubbers, vinyl chloride resins, vinyl acetate resins, polyester resins, phenolic resins, and silicone resins and adhesives such as silane coupling agents.

The adhesive layer may be composed of a layer of a single adhesive or layers of different adhesives. The adhesive layer may contain, for example, powders of carbon blacks such as conductive Ketjen black and acetylene black; various conductive metals and alloys such as aluminum, copper, nickel, chromium, and titanium; various conductive metal oxides such as tin oxide, indium oxide, titanium oxide, tin oxide-antimony oxide solid solution, and tin oxide-indium oxide solid solution; and insulating materials having the surface thereof made conductive. The thickness of the adhesive layer is preferably, but not limited to, 5 to 100 rim, more preferably 10 to 50 μm.

### (3.3) Resistive Elastic Layer

The resistive elastic layer (also referred to as “elastic layer”) 3 of the charging roller 1 may be made of, for example, a mixture of an elastic material such as rubber and a conductor, such as carbon black or an ionic conductor, for adjusting the resistance of the resistive elastic layer 3. The mixture may optionally contain other additives that are commonly added to rubber. Examples of other additives include softeners, plasticizers, curing agents, vulcanizing agents, vulcanization accelerators, antioxidants, and fillers such as silica and calcium carbonate.

The resistive elastic layer 3 is formed by applying a mixture containing additives that are commonly added to rubber to the circumferential surface of the conductive core 2. The conductor for adjusting the resistance may be, for example, a dispersion of a material that electrically conducts at least one of electrons and ions as charge carriers, such as carbon black or an ionic conductor added to a matrix. The elastic material may be a foam.

The elastic material used for the resistive elastic layer 3 is prepared by, for example, dispersing a conductor in a rubber. Examples of rubbers include isoprene rubber, chloroprene rubber, epichlorohydrin rubber, butyl rubber, urethane rubber, silicone rubber, fluorinated rubber, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether copolymer rubber, ethylene-propylene-diene terpolymer rubber (EPDM), acrylonitrile-butadiene copolymer rubber, natural rubber, and blends thereof. Typical examples of rubbers include silicone rubber, ethylene-propylene rubber, epichlorohydrin-ethylene oxide copolymer rubber, epichlorohydrin-ethylene oxide-allyl glycidyl ether copolymer rubber, acrylonitrile-butadiene copolymer rubber, and blends thereof.

These rubbers may be foamed or unfoamed. The conductor contained in the resistive elastic layer 3 is, for example, an electron conductor or an ionic conductor.

Examples of electron conductors include powders of carbon blacks such as Ketjen black and acetylene black; various conductive metals and alloys such as aluminum, copper, nickel, chromium, and titanium; various conductive metal oxides such as tin oxide, indium oxide, titanium oxide, tin oxide-antimony oxide solid solution, and tin oxide-indium oxide solid solution; and insulating materials having the surface thereof made conductive.

Examples of ionic conductors include perchlorates and chlorates of tetraethylammonium and lauryltrimethylammonium and perchlorates and chlorates of alkali metals such as lithium and alkaline earth metals such as magnesium.

These conductors may be used alone or in combination. The amount of conductor added may be, but not limited to, 1 to 60 parts by mass per 100 parts by mass of the rubber for electron conductors and 0.1 to 5.0 parts by mass per 100 parts by mass of the rubber for ionic conductors.

### (3.5) Surface Layer

The surface layer 4 may be made of a binder resin in which conductive or semiconductive particles are dispersed to control the resistance thereof. The surface layer 4 may have a resistivity of 10³ to 10¹⁴ Ωcm, preferably 10⁵ to 10¹² Ωcm, even more preferably 10⁷ to 10¹⁰ Ωcm. The surface layer 4 may have a thickness of 0.01 to 1,000 μm, preferably 0.1 to 500 μm, even more preferably 0.5 to 100 μm.

Examples of binder resins include acrylic resins, cellulose resins, polyamide resins, methoxymethylated nylon, ethoxymethylated nylon, polyurethane resins, polycarbonate resins, polyester resins such as polyethylene terephthalate (PET), polyolefin resins such as polyethylene, polyvinyl resins, polyarylate resins, polythiophene resins, fluorinated resins such as perfluoroalkoxy copolymer (PFA) and fluorinated ethylene-propylene copolymer (FEP), styrene-butadiene resins, melamine resins, epoxy resins, urethane resins, silicone resins, and urea resins.

Examples of conductive or semiconductive particles include the carbon blacks, metals, and metal oxides illustrated for the resistive elastic layer 3 and ionic compounds that provide ionic conductivity, such as quaternary ammonium salts. These materials may be used alone or as a mixture.

Optionally, one or more additives may be added, including antioxidants such as hindered phenols and hindered amines; inorganic fillers such as clay, kaolin, talc, silica, and alumina; organic fillers such as fine powders of fluorinated resins and silicone resins; and lubricants such as silicone oil. Other optional additives include leveling agents, surfactants, and charge control agents.

The surface layer 4 may be formed by a technique used in the related art, such as blade coating, Meyer bar coating, spray coating, dip coating, bead coating, air knife coating, or curtain coating.

### EXAMPLES

The present invention is further illustrated by the following examples and comparative examples, although these examples are not intended to limit the present invention.

### Fabrication of Charging Roller

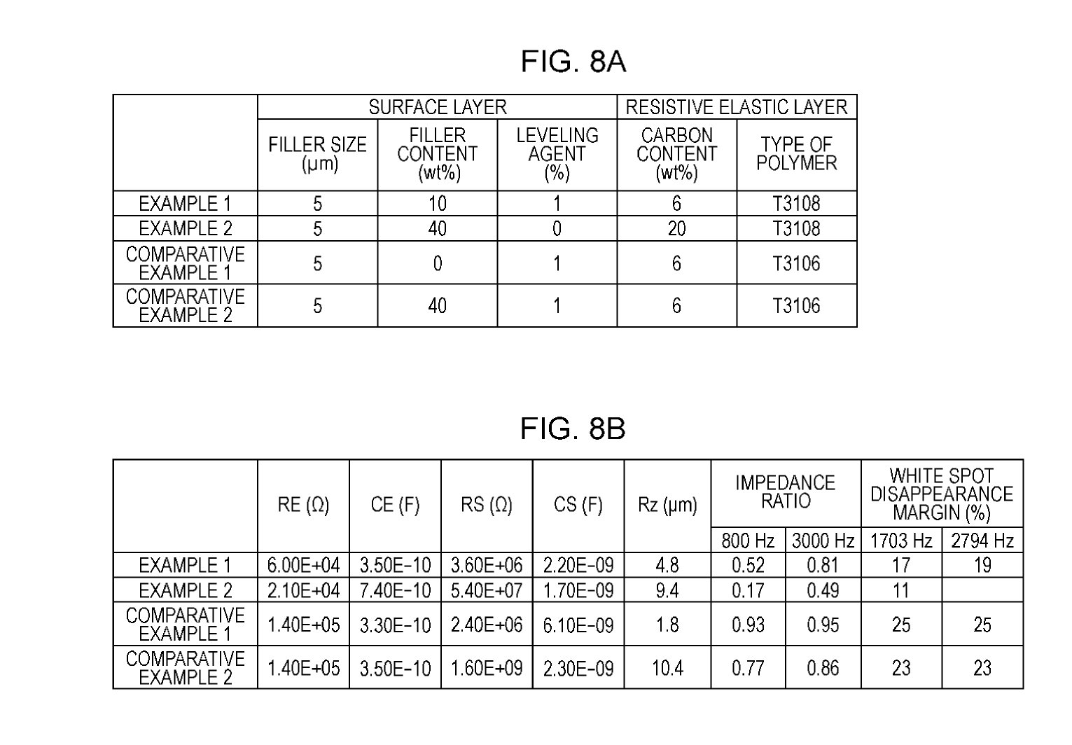

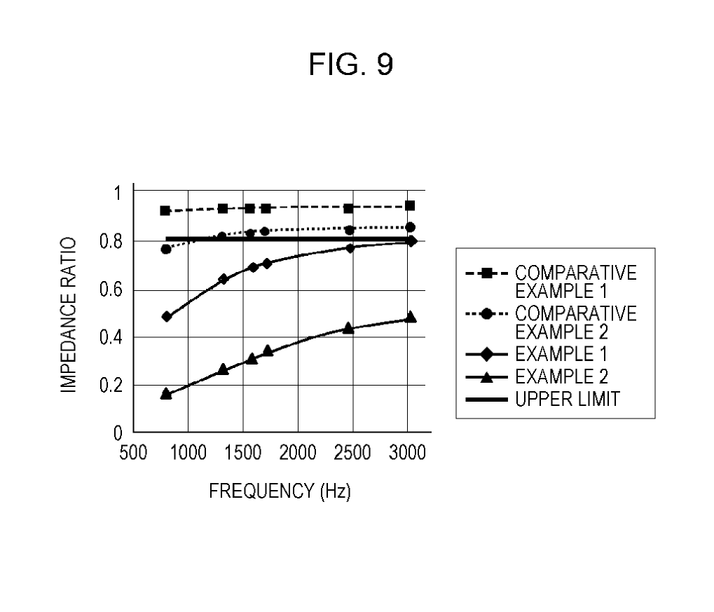

FIG. 8A shows the basic formulations for Examples 1 and 2 and Comparative Examples 1 and 2.

The polymer (epichlorohydrin rubber) shown in FIG. 8A is masticated in a 12 inch two-roll mill for three minutes. After mastication, the polymer is gradually mixed with carbon black, calcium carbonate, and an ionic conductor and finally with a vulcanizing agent and a vulcanization accelerator during the operation of the two-roll mill. The mixture is kneaded for five minutes to prepare a raw rubber for the resistive elastic layer 3.

Thereafter, the raw rubber is injected into a mold using an injection molding machine, is held for three minutes, and is removed from the mold.

The mold used is a cylindrical mold for injection molding with an inner diameter of 14.5 mm. The conductive core 2 is set in the cylindrical mold, which is maintained at 170° C.±5° C. by a heater.

The molded rubber is finished to an outer diameter of 12 mm using a traverse grinder to obtain an elastic roller. The ten-point average surface roughness Rz of the elastic roller in accordance with JIS B0601 (1982) is 6 μm. The outer diameter of the elastic roller is about 55 μm larger in the center thereof than at the ends thereof (crown shape).

The finished elastic roller is dipped in a solution for forming the surface layer 4 prepared by adding nylon particles with an average particle size of 5 μm as a filler in the amount shown in FIG. 8A per 100 parts by mass of solids in a conductive solution for forming the surface layer 4. The elastic roller is then pulled at a predetermined speed to form a coating of the solution for forming the surface layer 4 with an average thickness of 9 μm.

The coating is dried and baked to form a surface layer. The surface layer is polished using a polishing machine to form smooth portions at peaks in the surface of the surface layer. Thus, each charging roller 1 is fabricated.

### Measurement of Impedance Ratio

The charging rollers 1 of Examples 1 and 2 and Comparative Examples 1 and 2 are tested for the impedance ZE of the resistive elastic layer 3 and the impedance ZS of the surface layer 4 using the measurement scheme shown in FIG. 3.

The impedance is measured using a Solartron 1260 impedance analyzer. The charging roller 1 is brought into contact with and pressed against an aluminum pipe (metal conductor) having a diameter of 30 mm and a surface roughness Rmax of 1.6 μm or less with a pressing force of 5 N on one side. The charging roller 1 is at rest during the impedance measurement.

Specifically, the impedance is measured by applying an alternating voltage of 1 Vpp from higher frequencies over the frequency range of 1 MHz to 10 mHz in an environment at a temperature of 10° C. and a humidity of 15% RH.

### Evaluation of White Spot Disappearance Margin

The charging rollers 1 of Examples 1 and 2 and Comparative Examples 1 and 2 are used with the charging device of the image-forming apparatus 100 to determine the white spot disappearance margin.

The white spot disappearance margin, as described above, is the range from the knee-point current (Iac0) to the alternating current (Iac1) at which white spots disappear, that is, the magnitude of the alternating current (Iac1) at which white spots disappear relative to the knee-point current (Iac0). As the alternating current (Iac1) becomes lower, the charging roller 1 may be used at a lower alternating current. This may result in reduced wear of the photoreceptor drum 21 and a lower power consumption of the image-forming apparatus 100.

FIG. 8B shows the impedances measured and white spot disappearance margins determined in Examples 1 and 2 and Comparative Examples 1 and 2.

In Examples 1 and 2, the impedance ratio does not exceed 0.81 over a wide frequency range, i.e., 800 to 3,000 Hz.

In Comparative Examples 1 and 2, the impedance ratio exceeds 0.81 over the entire frequency range of 800 to 3,000 Hz.

As a result, the white spot disappearance margin determined when an alternating voltage (Vac) with a frequency of 1,703 Hz is applied to the image-forming apparatus 100 (process speed: 300 mm/sec) is 17% in Example 1, 11% in Example 2, 25% in Comparative Example 1, and 23% in Comparative Example 2.

The white spot disappearance margin determined when an alternating voltage (Vac) with a frequency of 2,794 Hz is applied to the image-forming apparatus 100 (process speed: 500 mm/sec) is 19% in Example 1, 25% in Comparative Example 1, and 23% in Comparative Example 2 (not measured in Example 2) .

Thus, a charging roller 1 having a reduced white spot disappearance margin may be provided if the impedance ratio measured at an environmental temperature of 10° C. or about 10° C. and a humidity of 15% RH or about 15% RH in a range of alternating voltage frequencies of the image-forming apparatus used of 800 to 3,000 Hz or about 800 to about 3,000 Hz satisfied |ZE/(ZE+ZS)|≦0.81.

The charging roller 1 of Example 1 is superior to that of Example 2 in both impedance ratio and white spot disappearance margin. The ten-point average surface roughness Rz of the surface layer 4 of Example 2 (Rz=9.4 μm) is larger than that of Example 1 (Rz=4.8 μm). The charging roller 1 of Example 2 is suitable, for example, for an image-forming apparatus that gives a higher priority to reduced wear of the photoreceptor than to image quality such as graininess.

It is desirable that the charging roller 1 be applicable to a wide range of apparatuses, including low-speed apparatuses and high-speed apparatuses, and there is a need for a higher image quality and a lower power consumption.

Accordingly, the impedance ratio is defined as a characteristic value that may be uniquely controlled. A charging roller 1 that allows for reduced white spots with reduced wear of the photoreceptor drum 21 may be provided if the impedances of the resistive elastic layer 3 and the surface layer 4 measured at an environmental temperature of 10° C. or about 10° C. and a humidity of 15% RH or about 15% RH in a range of alternating voltage frequencies of the image-forming apparatus used of 800 to 3,000 Hz or about 800 to about 3,000 Hz satisfy |ZE/(ZE+ZS)|≦0.81, where ZE is the impedance of the resistive elastic layer 3, and ZS is the impedance of the surface layer 4.

If the impedance of the photoreceptor drum 21 is added, the absolute value of the resulting impedance ratio is lower than that of the charging roller 1 alone. In this case, the impedance ratio is defined as |ZE/(ZE+ZS+ZC)|, where ZC is the impedance of the photoreceptor drum 21 (including the impedance of the undercoat layer). Thus, the above value may be used.

If the impedance of the photoreceptor drum 21 is added, the phase peak is shifted toward higher frequencies, and the combination does not adversely affect the control of the characteristic value. Thus, the properties of the charging roller 1 may be controlled depending on the measured impedance of the charging roller 1 alone.

The charging roller 1 and the photoreceptor drum 21 wear over time as they are used with the image-forming apparatus 100. However, because the amount of wear of the charging roller 1 is smaller than that of the photoreceptor drum 21, the impedance ratio does not increase over time as compared to the initial impedance ratio, and the white spot disappearance margin decreases.

The impedance ratio used as the characteristic value is measured in the environment where the image-forming apparatus 100 is used, i.e., at a temperature of 10° C. or about 10° C. and a humidity of 15% RH or about 15% RH. For example, the resistance RE of the resistive elastic layer 3 tends to be lower, and accordingly the impedance ratio is lower, in a normal environment (at a temperature of 20° C. and a humidity of 50% RH) and a high-temperature, high-humidity environment (at a temperature of 28° C. and a humidity of 85% RH). Thus, no problem arises even if the environment where the image-forming apparatus 100 is used varies.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging roller comprising:
a conductive core;
a resistive elastic layer disposed on the conductive core; and
a surface layer disposed on the resistive elastic layer, wherein the impedances of the resistive elastic layer and the surface layer measured at an environmental temperature of about 10° C. and a humidity of about 15% RH in a range of alternating voltage frequencies of an image-forming apparatus used satisfy:

|ZE/(ZE+ZS)|≦0.81
where ZE is the impedance of the resistive elastic layer, and ZS is the impedance of the surface layer.

2. A charging roller comprising:
a conductive core;
a resistive elastic layer disposed on the conductive core; and
a surface layer disposed on the resistive elastic layer,
wherein the impedances of the resistive elastic layer and the surface layer measured at an environmental temperature of about 10° C. and a humidity of about 15% RH in a range of alternating voltage frequencies of about 800 to about 3,000 Hz satisfy:

|ZE/(ZE+ZS)≡1≦0.81
where ZE is the impedance of the resistive elastic layer, and ZS is the impedance of the surface layer.

3. The charging roller according to claim 1, wherein the resistances and capacitances of the resistive elastic layer and the surface layer per unit length in an axial direction satisfy:
RE≦6.0×10⁴ Ω·m;
CE≧3.5×10⁻¹⁰ F/m;
RS≧3.6×10⁶ Ω·m; and
CS≦2.2×10⁻⁹ F/m,
where RE is the resistance of the resistive elastic layer, CE is the capacitance of the resistive elastic layer, RS is the resistance of the surface layer, and CS is the capacitance of the surface layer.

4. The charging roller according to claim 2, wherein the resistances and capacitances of the resistive elastic layer and the surface layer per unit length in an axial direction satisfy:
RE≦6.0×10⁴ Ω·m;
CE≧3.5×10⁻¹⁰ F/m;
RS≧3.6×10⁶ Ω·m; and
CS≦2.2×10⁻⁹ F/m,
where RE is the resistance of the resistive elastic layer, CE is the capacitance of the resistive elastic layer, RS is the resistance of the surface layer, and CS is the capacitance of the surface layer.
